(19) United States
(12) Patent Application Publication
(10) Pub. No.: US 2008/0036739 A1
(43) Pub. Date: Feb. 14, 2008

(54) Integrated Wireless Pointing Device, Terminal Equipment with the Same, and Pointing Method Using Wireless Pointing Device

(75) Inventors: Sung Chul Juh, Seoul (KR); Kyoung Un Chung, Seoul (KR); Dong Jung Yong, Seoul (KR); Kyu Min Hwang, Seoul (KR)

Correspondence Address: VENABLE LLP, P.O. BOX 34385, WASHINGTON, DC, 20043-9998, US

(73) Assignees: MOBISOL INC., Seoul (KR); KOREA ELECTRONICS TECHNOLOGY INSTITUTE, Seongnam-si (KR)

(21) Appl. No.: 11/596,587

(22) PCT Filed: May 17, 2005
(86) PCT No.: PCT/KR05/01445

§ 371 Date: Nov. 15, 2006

(30) Foreign Application Priority Data
May 17, 2004 (KR) 10-2004-0034692
Feb. 17, 2005 (KR) 10-2005-0013176

(51) Int. Cl. G06F 3/033; G06F 3/02; G06F 3/037

(52) U.S. Cl. 345/161; 345/168; 345/180

(57) ABSTRACT

A wireless pointing device, a terminal equipment with the same, and a pointing method using the wireless pointing device are disclosed. A disclosed wireless pointing device includes a lighting means, an image acquisition area, an image formation means, a light receiving means, a movement detection means, and a wireless communication means. The subject is the surface of a finger, a lattice pattern or a perceivable pattern. One example wireless pointing device is combined with a fingerprint sensor to collect a user's fingerprint during operation of the pointing device and compare the fingerprint with an existing registered fingerprint without a separate fingerprint authentication procedure. A disclosed wireless pointing method includes displaying and activating menu items requiring a settlement service and personal information if a user's fingerprint is identical with a registered fingerprint, and deactivating menu items requiring a settlement service and personal information if a user's fingerprint is not identical with a registered fingerprint.

### TECHNICAL FIELD

The present invention relates to a wireless pointing device, a terminal equipment with the same, and a pointing method using the wireless pointing device; and, more particularly, a micro wireless pointing device that a wireless device is integrated into a general pointing device, a terminal equipment with a wireless pointing device that the micro wireless pointing device is integrated into a terminal equipment, and a method of identifying a user through fingerprint authentication by the wireless pointing device and restricting use of an electronic device.

### BACKGROUND ART

An interactive set-top box which is recently spread is linked with a television set. Thus, a remote controller is preferred to a keyboard as an input-output device for the set-top box. A conventional remote controller for controlling an electronic equipment employs number-key or direction-key buttons for movement among menu items and selection of a particular menu. However, with generalization of Graphic User Interface (GUI) for user's convenience, a pointing device has substituted functions of key buttons such as movement among menu items and selection of a particular menu.

On the other hand, multimedia products such as wide-screen TV sets make online home shopping or internet electronic commerce possible by adopting bidirectional communication out of simplex communication between a provider and a user. Such electronic commerce service needs user identification using a personal authentication program and a password in order to ensure personal information security and safe electronic-settlement and prevent use and unfair settlement by an unauthorized person. However, the password may leak out to other persons.

Recently, a safe settlement system using a person's intrinsic fingerprint has been developed. However, the settlement system using a fingerprint needs a separate fingerprint sensor and a finger has to be in contact with the fingerprint sensor for comparison of the fingerprint during identification. In addition, a user may feel opposition to such fingerprint identification.

As a conventional technology, the Korean Patent Publication No. 2003-0000163 to Zenersys IT Co. Ltd., discloses a wireless mouse for computer security for preventing leakage of internet information by giving a mouse with a voice password of a user regardless of a position and a pose of the user. As another conventional art, the Korean Patent Publication No. 2004-0012441 to Fujitsu Limited, discloses a processor with personal recognition function and operation equipment which makes personal authentication, personal identification constantly possible, which can be operated by space-saving without burdening a user in a personal recognition device. The Fujitsu's processor conducts personal authentication and personal identification by photographing blood vessel images of palms and identifying a user based on the photographed blood vessel image.

However, the above-mentioned conventional technologies are not applicable to a small device such as a mouse because an additional device, such as a voice recognition module, a blood vessel image photographing device, or a recognition part for personal authentication and personal identification, has to be contained in the mouse.

On the other hand, a keyboard is one of chief input-output devices to communicate with a computer system. The keyboard comprises a key-matrix which generates a value of a key pressed on a keypad, a keyboard buffer which stores pro tempore the value of key generated from the key-matrix before it is transferred to a computer mainframe, and a keyboard controller which controls the keyboard. In addition, the keyboard includes a pointing means such as a track ball or touch pad functioning as a mouse therein. A mouse is one of input-output devices and freely moves a pointer on a computer screen. The mouse can rapidly select and run a menu on a display, and appoint a desired location.

With popularization of computers, a keyboard and mouse having a wireless function are being widely applied to electronic products. Currently, a variety of wireless keyboard mounted with a ball mouse have been released. However, the ball mouse is large in size and heavy in weight, and may frequently malfunction due to dust on the ball because the ball is directly contact with a finger, thereby having a lower reliability.

A joystick as another input device provides information about direction and speed. For an accurate control, a high degree of training and concentration are required. FIG. 1 illustrates examples of a conventional joystick. As shown in FIG. 1 (a)˜(c), most of joystick for game, industrial joystick, or aircraft joystick move only in up-down and left-right directions. Thus, it is very difficult to conduct precise control by using the conventional joystick.

### DISCLOSURE

### Technical Problem

Accordingly, the present invention is directed to a wireless pointing device, a terminal equipment with the same, and a pointing method using the wireless pointing device that substantially obviate one or more problems due to limitations and disadvantages of the related art.

An object of the present invention is to provide a wireless micro pointing device that a wireless device is combined with a conventional pointing device. In addition, by integrating a fingerprint sensor to the wireless pointing device, the present invention provides an integrated wireless micro pointing device which can collect a user's fingerprint during operation of the pointing device and compare the fingerprint with an existing registered fingerprint without a separate fingerprint authentication procedure.

Another object of the present invention is to provide a wireless pointing method so as to easily select a desired menu item, prevent leakage of personal information, and restrict the use of an electronic equipment by unauthorized persons. A disclosed method includes displaying and activating menu items requiring a settlement service and personal information if a user's fingerprint is identical with a registered fingerprint, and deactivating menu items requiring a settlement service and personal information so that the pointing device can be used as a general pointing means if a user's fingerprint is not identical with a registered fingerprint.

Another object of the present invention is to provide a keyboard and joystick having an integrated wireless pointing device usable anywhere, by mounting a dust-proof and integrated micro pointing device into a keyboard or joystick and linking the keyboard or joystick with the micro pointing device to a computer system using a single wireless device.

### Technical Solution

To achieve these objects and other advantages and in accordance with the purpose of the invention, as embodied and broadly described herein, this invention provides a wireless pointing device comprising a lighting means for illuminating a subject; an image acquisition area for acquiring an image through the light illuminated; an image formation means for forming an image on an opposite side by condensing the light reflected from the image acquisition area; a light receiving means for converting the image formed by the image formation means into electric signals; a movement detection means for detecting change in movement of the image using output from the light receiving means; and a wireless communication means for transferring data of the movement detection means. Here, the subject is the surface of a finger, a lattice pattern or a perceivable pattern.

Another object of the present invention is achieved by a wireless pointing device comprising a lighting means for illuminating a subject, an image acquisition area for acquiring an image through the light illuminated, an image formation means for forming an image on an opposite side by condensing the light reflected from the image acquisition area, a light receiving means for converting the image formed by the image formation means into electric signals, a movement detection means for detecting change in movement of the image using output from the light receiving means, a fingerprint comparison means for comparing a fingerprint image transferred from the light receiving means, and a wireless communication means for transmitting the data from the movement detection means and the fingerprint comparison means.

Another object of the present invention is achieved by a wireless pointing method comparing the steps of acquiring and sampling a fingerprint image by using a wireless pointing device having a fingerprint identification function; computing displacement data of the sampled fingerprint image; estimating coordinates of a pointer using the displacement data; and moving the pointer based on the coordinates. The wireless pointing method further comprises (a) comparing the features of the fingerprint image acquired by a wireless pointing device with the same of an existing registered fingerprint image; (b) selectively displaying menu items according to the result of the step (a); and (c) selecting a desired menu item among the menu items displayed in the step (b) using the wireless pointing device.

Another object of the present invention is achieved by a keyboard and joystick with an integrated pointing device comprising a lighting means for illuminating a subject; an image acquisition area for acquiring an image through the light illuminated; an image formation means for forming an image on an opposite side by condensing the light reflected from the image acquisition area; a light receiving means for converting the image formed by the image formation means into electric signals; a movement detection means for detecting change in movement of the image using output from the light receiving means; and a wireless communication means for transferring data from the movement detection means.

### BRIEF DESCRIPTION OF THE DRAWINGS

FIG. 1 illustrates examples of a conventional joystick.

FIG. 2 is a schematic diagram illustrating an electronic equipment including a wireless pointing device in accordance with the present invention.

FIG. 3 shows examples of a remote controller mounted with a wireless pointing device in accordance with the present invention.

FIG. 4 illustrates a ball-point pen mounted with a wireless pointing device in accordance with the present invention.

FIG. 5 shows examples of a keyboard mounted with a wireless pointing device in accordance with the present invention.

FIG. 6 is examples of a joystick mounted with a wireless pointing device in accordance with the present invention.

FIG. 7 is a flow chart describing a wireless pointing method in accordance with the present invention.

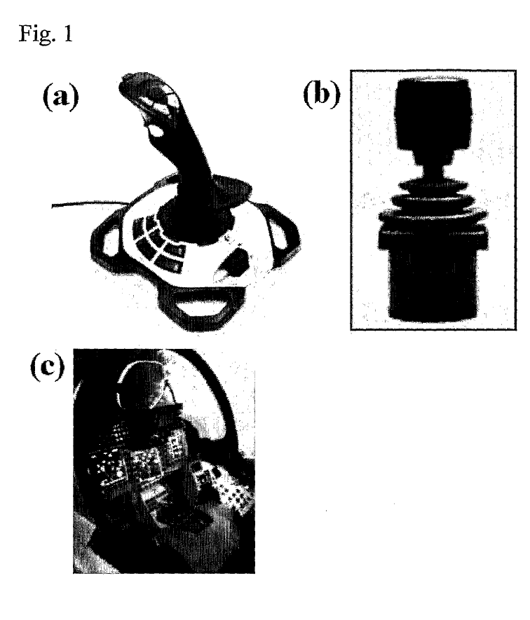

### BEST MODE FOR CARRYING OUT THE INVENTION

Further objects and advantages of the invention can be more fully understood from the following detailed description taken in conjunction with the accompanying drawings.

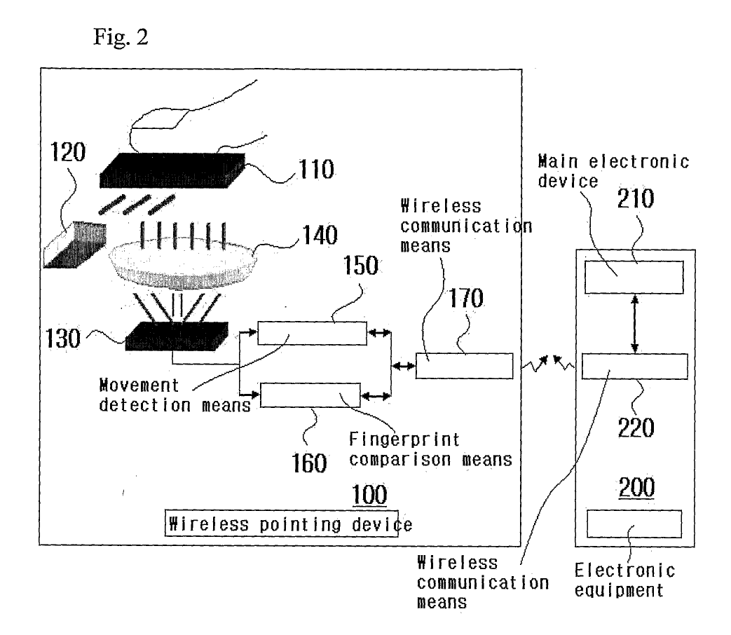

FIG. 2 is a schematic diagram illustrating an electronic device having a wireless pointing device in accordance with teachings of the present invention. As shown in FIG. 2, light emitted from a lighting means (120) of a wireless pointing device (100) having a fingerprint authentication function is illuminated on the surface of a finger. The light is reflected according to the pattern of the surface of the finger. The reflected light from the surface of the finger passes through an image formation means (110) and forms an image on a light receiving means (130). The image formed on the light receiving means (130) is converted into a digital fingerprint image. Such a process to acquire a digital fingerprint image is very rapidly and continuously performed on a timing axis. Two-dimensional movement and a fingerprint image are sampled from the light receiving means (130) and transferred to a movement detection means (150) and a fingerprint comparison means (160), respectively. Then, a wireless communication means (170) transfers the data of the movement detection means (150) and fingerprint comparison means (160) to a wireless communication means (220) of an electronic equipment (200). The wireless communication means (220) controls a main electronic device (210) using the transferred data. The wireless pointing device (100) with a fingerprint authentication function includes, for example, a remote controller. The electronic equipment (200) may be, for example, TV sets or an audio.

The wireless pointing device (100) comprises an image acquisition area (110), a lighting means (120), a light receiving means (130), an image formation means (140), a movement detection means (150), a fingerprint comparison means (160), and a wireless communication means (170).

The lighting means (120) illuminates a movable subject. The lighting means (120) may be, for example, a light emitting diode, a laser diode, or an organic electro-luminescence (EL).

The image acquisition area (110) acquires movement data through the light from the lighting means (120). The image acquisition area is preferably formed of a transparent member the surface of which is flat. The transparent member is arranged so as to space between a subject such as a finger and an image-formation area of the image formation means (140). The transparent member may be coated with an appropriate material to prevent damage or contamination of the image acquisition area (110). In some implementations, the image acquisition area (110) may be a virtual plane formed at a predetermined distance from the image-formation means (140).

The image formation means (140) condenses the light reflected from the image acquisition area (110) and forms an image on an opposite side. The image formation means (140) is formed of an optical lens, preferably, a spherical lens, aspherics, or a lens using hologram.

The light receiving means (130) converts an analog image condensed by the image formation means (140) into a digital image. The light receiving means (130) includes an optical sensor array in which a plurality of CMOS (complementary metal-oxide-semiconductor) image sensors or CCD (charge coupled device) image sensors are arranged two-dimensionally. The light receiving means (130) has a very small size so that it is applicable to a small-sized portable equipment and acquires a small fingerprint image.

The movement detection means (150) estimates the degree of movement using a digital image received from the light receiving means (130). The movement detection means (150) computes the degree of movement of a fingerprint by calculating displacement data (direction and distance) according to movement of the fingerprint using a motion estimation method. The movement detection means (150) uses a motion estimator.

The fingerprint comparison means (160) compares a fingerprint image transferred from the light receiving means (130) with an existing registered fingerprint and determines whether the present user is a registered user or not. Here, the light receiving means (130), the movement detection means (150), and the fingerprint comparison means (160) are formed of a single IC chip. Additionally, the image acquisition area (110) and the image formation means (140) may be integrally formed.

The wireless communication means (170) transmits data of the movement detection means (150) and the fingerprint comparison means (160) using radio frequency, bluetooth, wireless LAN, IrDA (infrared data association), ultrasound, etc. In some implementations, when the wireless pointing device is mounted into a terminal such as a keyboard or joystick, the wireless communication means (170) can transmits input data of the terminal to the electronic equipment (200) by transferring data using a protocol in which data from the pointing device and data from the terminal are incorporated.

Accordingly, by installing the wireless communication means (170) so that the data of a pointing device and data of a terminal can be multiplexed, the present invention realizes miniaturization and reduces power dissipation.

In some implementations, the image acquisition area (110), the lighting means (120), the light receiving means (130), the image formation means (140), the movement detection means (150) and the fingerprint comparison means (160) may be integrally sealed to form a micro wireless pointing device. Additionally, the integrally sealed micro wireless pointing device may include a contact sensor therein so as to turn on a light source and normally work only when a finger or a subject is contact with the contact sensor, thereby reducing power dissipation. Moreover, the light source is preferably installed so as not to directly illuminate user's eyes to protect the same.

In another implementation, the wireless pointing device according to the present invention may include a light guide structure (not shown) to form parallel light between the image formation means (140) and the image acquisition area (110). By making the light transferred to the image-acquisition area (110) nearly parallel, influence due to change of lighting condition can be minimized, and the light emitted from the lighting means (120) can be uniformly distributed, thereby constantly maintaining lightness in a predetermined area.

The electronic equipment (200) in accordance with the present invention comprises a main electronic device (210) and a wireless communication means (220). The main electronic device (210) may be, for example, TV sets or an audio. The wireless communication means (220) receives data transmitted from the wireless communication means (170) of the wireless pointing device (100) having a fingerprint authentication function.

In addition, the wireless pointing device in accordance with the present invention may be used without the fingerprint authentication function. A wireless pointing device without fingerprint authentication comprises an image acquisition area, a lighting means, a light receiving means, an image formation means, a movement detection means, and a wireless communication means.

In the wireless pointing device without fingerprint authentication, light emitted from the lighting means illuminates a finger and is reflected along the pattern of the surface of the finger. The light reflected from the surface of the finger passes through the image formation means and forms an image on the light receiving means. The formed image is converted into a digital fingerprint image by the light receiving means.

Such a fingerprint image acquisition is very rapidly and continuously performed on a timing axis. Data of two-dimensional movement and fingerprint image detected from the light receiving means are transferred to a movement detection means. Then, the wireless communication means transmits data of the movement detection means to a wireless communication means of an electronic equipment. The wireless communication means of the electronic equipment controls a main electronic equipment using the data transmitted.

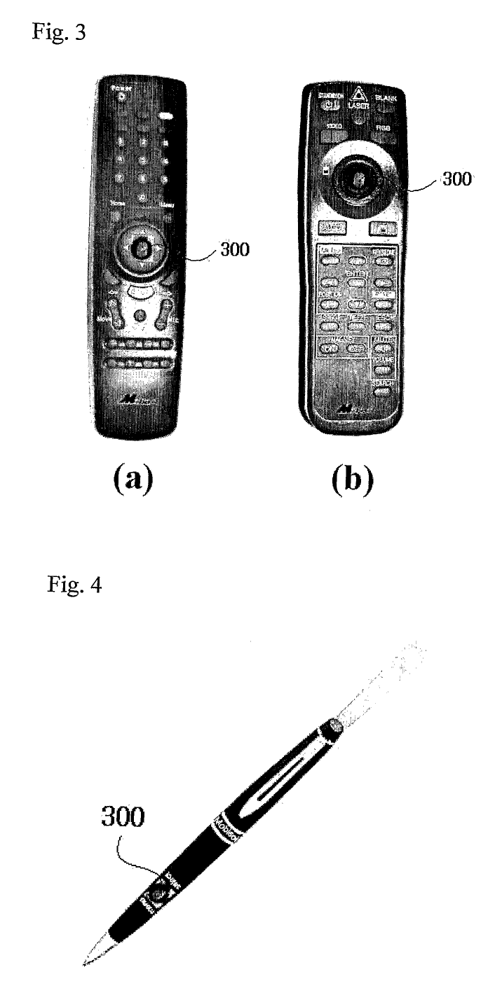

FIG. 3 shows examples of a remote controller mounted with a wireless pointing device in accordance with the present invention. FIG. 3 (a) illustrates a wireless pointing device (300) which is installed on the center of a remote controller to transmit data together with keystroke input. FIG. 3 (b) shows a wireless pointing device (300) which is installed on the upper part of a remote controller to transmit data together with keystroke input.

FIG. 4 illustrates a ball-point pen having a wireless pointing device therein. The wireless pointing device (300) mounted in the ball-point pen in accordance with the present invention can control home appliances. The wireless pointing device (300) having its own wireless communication means interchanges data with a wireless communication means of an electronic equipment.

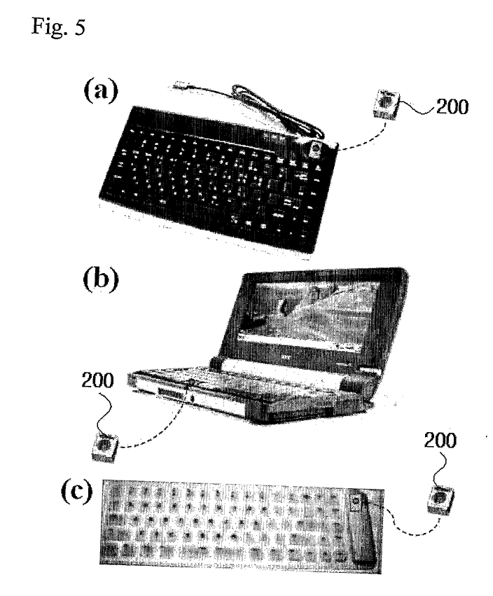

FIG. 5 shows examples of a keyboard mounted with a wireless pointing device in accordance with the present invention. Referring to FIG. 5 (a), a pointing device (200) is installed in a predetermined location on the keyboard to transmit input data of the keyboard and data of the pointing device. Referring to FIG. 5 (b), a pointing device (200) is installed near a space bar of a keyboard in a notebook computer. Referring to FIG. 5 (c), a pointing device is mounted in a predetermined location in a roll-up keyboard. The pointing device (200) is not damaged even though the keyboard is folded in once or more. The folded section is formed of a flexible printed circuit board or resilient connector so that it is not broken during folding. The keyboard in accordance with the present invention includes at least one selection button, which is combined with the pointing device, to select a menu item indicated by a pointer or enter executive instructions. In addition, the keyboard preferably uses a secondary battery as a main power source.

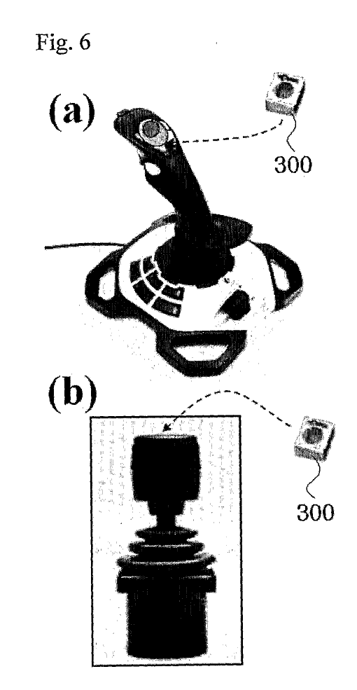

FIG. 6 illustrates examples of a joystick having a wireless pointing device in accordance with the present invention. Referring to FIG. 6 (a), a pointing device (300) is mounted in a predetermined position on a joystick for games to transmit input data of the joystick and pointing device. Referring to FIG. 6 (b), a pointing device (300) is installed in an industrial joystick. The joystick in accordance with the present invention includes at least one selection button, which is combined with the pointing device, to select a menu item indicated by a pointer or enter executive instructions. In addition, the joystick preferably uses a secondary battery as a main power source.

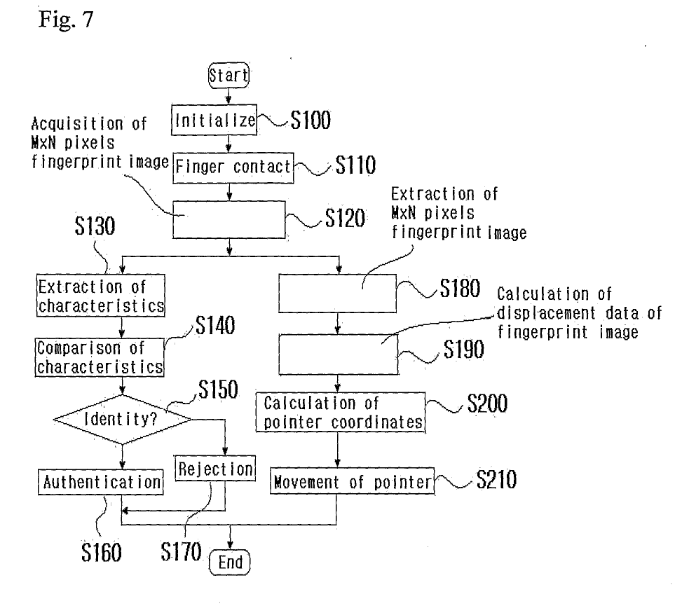

FIG. 7 is a flow chart describing a wireless pointing method in accordance with the present invention. Referring to FIG. 7, a pointing device is first initialized (S100). A user's finger is contact with an image acquisition area of the pointing device (S110). Then, a fingerprint image of M×N pixels is obtained by a fingerprint acquisition sensor (S120). User authentication is performed by using minutiae of the whole fingerprint image obtained in a predetermined period. At the same time, controlling a pointer is conducted by using a small-sized fingerprint image sampled from the whole fingerprint image acquired in a predetermined period. The whole fingerprint image has a size necessary for user authentication, preferably, a size between 90×90 pixels and 400×400 pixels. The small-sized fingerprint image has a size necessary for controlling a pointer, preferably, a size between 15×15 pixels and 80×80 pixels.

If a fingerprint image of M×N pixels is obtained (S1120), a user identification procedure and a pointer control procedure are simultaneously performed. The user identification and pointer control procedures are independently conducted according to a predetermined period, respectively.

User identification is spontaneously conducted in a predetermined period while a user controls a pointer using his/her fingerprint. Thus, without requiring finger authentication for a user, user's fingerprint can be automatically identified during pointer controlling, and, based on the result of the fingerprint authentication, the user is allowed to selectively or completely access to an electronic equipment.

Referring to the user authentication procedure, minutiae of the obtained fingerprint image are extracted (S130). Extracted minutiae are compared with those of an existing registered fingerprint (S140) to determine whether minutiae are identical to those of the registered fingerprint or not (S150). If minutiae are identical, the user is allowed to access to an electronic equipment (S160). If minutiae are not identical, the user's access is restricted (S170).

The steps (S160) and (S170) result in displaying different information, respectively. If a user is identified as an allowable one during the user authentication procedure (S160), whole information stored is displayed. However, if the user fails to be authorized (S170), menu items are selectively displayed.

Therefore, for personal information security, an unauthorized user is not allowed to access to user's personal information, system control information, electronic commerce, etc. When a user wants to access to personal information using another function key, he or she can try access through fingerprint authentication.

Referring to pointer control, a fingerprint image of M×N pixels is first sampled from an acquired fingerprint image (S180). Displacement data of each fingerprint image sampled is computed (S190). Pointer coordinates are calculated from the displacement data (S200). Then, the pointer is moved into the coordinates calculated (S210).

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

### INDUSTRIAL APPLICABILITY

Accordingly, by integrating a pointing device and a fingerprint sensor, a wireless pointing device and pointing method in accordance with the present invention can identify whether a user is authorized or not without performing a separate process to identify a user's fingerprint image, and at the same time restrict usable functions based on the result of authentication, thereby preventing leakage of personal information.

What is claimed is:

1. A wireless pointing device comprising:
a lighting means for illuminating a subject;
an image acquisition area for acquiring an image through the light illuminated;
an image formation means for forming an image on an opposite side by condensing the light reflected from the image acquisition area;
a light receiving means for converting the image formed by the image formation means into electric signals;
a movement detection means for detecting change in movement of the image using output from the light receiving means; and
a wireless communication means for transferring data of the movement detection means,
wherein the subject is the surface of a finger, a lattice pattern, or any perceivable patterns.

2. A wireless pointing device as defined by claim 1, further comprising a fingerprint comparison means for comparing a fingerprint image transferred from the light receiving means when the subject is the surface of a finger, and a wireless communication means which transmits data of the movement detection means and a fingerprint comparison means.

3. A wireless pointing device as defined by claim 1, wherein the wireless communication means is one of radio frequency, bluetooth, wireless LAN, IrDA (Infrared Data Association), and ultrasound.

4. A wireless pointing device as defined by claim 1, wherein the lighting means is one of a light emitting diode, a laser diode, and an organic electro-luminescence.

5. A wireless pointing device as defined by claim 1, wherein the image acquisition area is a transparent member or virtual plane which is formed at a predetermined distance from the image formation means.

6. A wireless pointing device as defined by claim 1, wherein the image formation means is a spherical lens, an aspheric lens, or a lens utilizing holographic optical elements.

7. A wireless pointing device as defined by claim 1, further comprising a light guide structure for guiding the light emitted from the lighting means to the subject.

8. A wireless pointing device as defined by claim 1, wherein the light receiving means is a CMOS (complementary metal-oxide-semiconductor) image sensor or a CCD (charge coupled device) image sensor.

9. A wireless pointing device as defined by claim 2, wherein the light receiving means, the movement detection means, and the fingerprint comparison means are integrated into a single IC chip.

10. A wireless pointing device as defined by claim 1, wherein the image acquisition area and the image formation means are integrally combined.

11. A wireless pointing device as defined by claim 1, wherein the pointing device further comprises a contact sensor which turns on a light source and enables operation only when the subject touches the contact sensor.

12. A wireless pointing method comprising the steps of:
acquiring and sampling a fingerprint image by using a wireless pointing device having a fingerprint identification function;
computing displacement data of the sampled fingerprint image;
estimating coordinates of a pointer using the displacement data; and
moving the pointer based on the coordinates,
wherein the wireless pointing method further comprises (a) comparing the features of the fingerprint image acquired by a wireless pointing device with the same of an existing registered fingerprint image; (b) selectively displaying menu items according to the result of the step (a); and (c) selecting a desired menu item among the menu items displayed in the step (b) using the wireless pointing device.

13. The pointing method as defined by claim 12, wherein the step (b) displays whole information if minutiae of a user's fingerprint are identical to minutiae of a registered fingerprint and selectively displays menu items if not.

14. A keyboard comprising integrally the wireless pointing device as defined by claim 1.

15. The keyboard as defined by claim 14, wherein the wireless pointing device further comprises a fingerprint comparison means for comparing fingerprint images transferred from the light receiving means.

16. The keyboard as defined by claim 15, wherein the fingerprint comparison means transmits data to a wireless communication means.

17. The keyboard as defined by claim 14, wherein the keyboard further comprises a selection button which is integrally combined with the wireless pointing device and uses a secondary battery as a main power source.

18. A joystick comprising integrally the wireless pointing device as defined by claim 1.

19. The joystick as defined by claim 18, wherein the wireless pointing device further comprises a fingerprint comparison means for comparing fingerprint images transferred from the light receiving means.

20. The joystick as defined by claim 19, wherein the fingerprint comparison means transmits data to a wireless communication means.

21. The joystick as defined by claim 18, wherein the joystick further comprises a selection button which is integrally combined with the wireless pointing device and uses a secondary battery as a main power source.
